(19) United States
(12) Patent Application Publication
(10) Pub. No.: US 2025/0100117 A1
(43) Pub. Date: Mar. 27, 2025

(54) ELECTRIC TOOL

(71) Applicant: MAXELL IZUMI CO., LTD., Matsumoto-shi, Nagano (JP)

(72) Inventor: Masaki MIYAZAWA, Matsumoto-shi, Nagano (JP)

(21) Appl. No.: 18/832,103

(22) PCT Filed: Feb. 13, 2023
(86) PCT No.: PCT/JP2023/004736

§ 371 Date: Jul. 23, 2024

(30) Foreign Application Priority Data
May 31, 2022 (JP) 2022-088791

(51) Int. Cl. B25B 28/00; H01R 43/042

(52) U.S. Cl. CPC B25B 28/00; H01R 43/0428

(57) ABSTRACT

An electric tool comprises a main body having an electric motor, a feed screw, a slide part, a current sensor, a lower limit switch, and a control part, and a tool head. The slide part is moved backward to a position where a work can be machined, and then the slide part is moved forward to a position where the machined work can be removed. The control part performs a subsequent continuous process when a detection value of the current sensor exceeds a first current value and does not exceed a second current value at a point in time when the lower limit switch is activated, and performs an abnormality process when the second current value is exceeded at the point in time when the lower limit switch is activated.

### TECHNICAL FIELD

The present invention relates to an electric tool for processing a work.

### BACKGROUND ART

Conventionally, an electric tool having a configuration in which a crank-type gripping lever and an electric motor are combined is known (PTL 1: EP 2872293). The electric tool of PTL 1 has a configuration in which the distal end side of the tool head is open in the initial state, the distal end side of the tool head is closed by a gripping force of the operator gripping the gripping lever to hold the work, and the electric motor is actuated to close the distal end side of the tool head to process the work when the gripping force exceeds a specified value.

### CITATION LIST

### Patent Literature

PTL 1: EP2872293

### SUMMARY OF INVENTION

### Technical Problem

When a crimping terminal and an electric wire are crimped at a work site, it is necessary to align the crimping terminal and the electric wire. Also, when a crimping sleeve is compressed to join electric wires together at a work site, it is necessary to align the compression sleeve with each electric wire.

However, with the electric tool of PTL 1, since it is necessary to align the crimping terminal and electric wire and to align the compression sleeve and electric wires while maintaining a state in which the gripping lever, which is coupled to the jaw on one side, is gripped with a gripping force within a range not exceeding the specified value, the external force applied to the jaw on one side and the external force applied to the jaw on the other side tend to be unbalanced due to the structure, resulting in a large load on the electric motor. The distal end sides of the jaws have a male shape and a female shape, and if a processing operation is performed with the worn male and female shapes, insufficient compression or insufficient crimping would occur, resulting in wasteful power consumption.

### Solution to Problem

The present invention is made in view of the above circumstances, and it is an object of the present invention to provide an electric tool that has a structure with a high level of safety while improving the reliability of processing operations.

The present invention has been accomplished under the solutions as disclosed below.

An electric tool according to the present invention includes: a main body including an electric motor, a feed screw to be actuated by the electric motor, a slide part to be moved by the feed screw, and a control part; and a tool head that is coupled to the main body and includes a first jaw and a second jaw coupled to each other in a pivotal manner, wherein the tool head is provided with a spring that urges a distal end side of the first jaw and a distal end side of the second jaw in directions toward each other, processes a work with a first shape part of the distal end side of the first jaw and a second shape part of the distal end side of the second jaw, and includes a current sensor that detects a current of the electric motor and a lower limit switch that is to be activated by movement of the slide part to a lower limit position, and the control part determines that processing of the work is normal and performs a subsequent continuous process when a detection value of the current sensor exceeds a first current value and does not exceed a second current value at a point in time when the lower limit switch is activated, and determines that there is an abnormality and performs an abnormality process when the second current value is exceeded at the point in time when the lower limit switch is activated.

According to this configuration, since the subsequent continuous process can be immediately performed when the control part determines that the work has been processed normally, it is possible to limit power consumption while improving the reliability of processing operations. Also, when the control part determines that a current abnormality has occurred, an abnormality process can be immediately performed, thereby achieving a structure with a high level of safety.

The control part preferably continues actuation of the feed screw when the detection value does not exceed the first current value at the point in time when the lower limit switch is activated, determines that processing of the work is normal and performs a subsequent continuous process when the detection value is below the second current value at a point in time when a set time has elapsed since the detection value exceeds the first current value, and determines that there is an abnormality and performs the abnormality process when the detection value exceeds the second current value at the point in time when the set time has elapsed. According to this configuration, when the male shape and the female shape of the distal end sides of the jaws are worn, the actuation of the feed screw continues. When the detection value is below the second current value at the point in time when a set time has elapsed since exceeding the first current value, the control part determines that the work has been processed normally and can immediately perform the subsequent continuous process, thereby further increasing the reliability of the processing operation while taking into account the degree of wear on the male shape and the female shape of the distal end sides of the jaws. Furthermore, when the detection value exceeds the second current value at the point in time when the set time has elapsed, it is determined that there is an abnormality, and an abnormality process can be performed immediately, resulting in a structure with a high level of safety.

The main body preferably includes a display part, the lower limit switch, an intermediate switch that is activated by movement of the slide part to an intermediate position, and an upper limit switch that is activated by movement of the slide part to an upper limit position, the control part preferably performs control that moves the slide part to the intermediate position when the control part determines that the processing of the work is normal, or performs control that moves the slide part to the upper limit position and moves the slide part to the intermediate position when the control part determines that the processing of the work is normal, and the control part preferably transmits an error signal to the display part when it determines that there is an abnormality. According to this configuration, when the work has been processed normally, the subsequent continuous process can be immediately performed in either the automatic mode or the manual mode. Furthermore, when a current abnormality occurs, an error message is displayed immediately, allowing early detection of equipment abnormalities.

In one example, the main body includes a trigger switch and a control switch, and the control part performs stop control that moves the slide part to the intermediate position and stops the slide part when the trigger switch is released and the control switch is operated before the lower limit switch is activated, and performs the stop control when neither the trigger switch nor the control switch is operated after a stand-by time has elapsed since the point in time when the intermediate switch is activated. According to this configuration, stop control can be performed when the operator catches his/her finger on the tool head after starting processing of the work, for example, thereby further improving the safety of the operation. Also, by performing stop control when the operator catches his/her finger on the tool head with the distal end side of the first jaw and the distal end side of the second jaw opened in the automatic mode, for example, the safety of the operation is further improved.

In one example, the control part performs mode switching control that, in response to the control switch being operated while the power is ON and the electric motor is stopped, alternately switches between an automatic mode that repeatedly performs operation of processing the work from a state in which the distal end side of the first jaw and the distal end side of the second jaw are open, and a manual mode that performs operation of processing the work one by one from a state in which the distal end side of the first jaw and the distal end side of the second jaw are closed.

In one example, the second jaw is provided with an operation part that, when operated by an operator while the slide part is at the intermediate position, separates the first shape part and the second shape part from each other so as to allow the work to be removed. According to this configuration, when the operator presses the operation part of the second jaw while the slide part is at the intermediate position, the distal end side of the second jaw is separated from the distal end side of the first jaw. This facilitates the attachment of the work and the alignment of the work, providing satisfactory usability. In one example, the main body has a cover part, and a guide plate, which corresponds in shape to a finger of an operator, is attached to the position of the operation part of the second jaw that is pressed by the operator. As the cover part, a resin molded product, or a metal pressed product having an inner wall with insulating treatment may be used.

The main body is preferably provided with a trigger switch that is activated in conjunction with a trigger lever operated by the operator so that the control part drives the electric motor, and a control switch that is activated by operation by the operator so that the control part enables activation of the trigger switch. The intermediate switch is preferably activated by movement of the slide part to the intermediate position, and when the slide part is at the intermediate position, the rear end side of the first jaw and the first roller are preferably separated, and the rear end side of the second jaw and the second roller are preferably separated. According to this configuration, while the simple configuration in which the control switch and the trigger switch are combined is provided, the operator can easily perform a series of necessary operations with one hand, and thus the usability is satisfactory, with consideration given to safety.

In one example, the feed screw is supported by a bearing and coupled to the electric motor via a speed reducer. According to this configuration, it is possible to reduce the rotational friction generated by the load in the thrust direction received when the feed screw moves the slide part. One example is a slide part that is coupled to a nut with which the rotational movement of the feed screw is converted into liner movement, or a slide part that is formed integrally with the nut. A ball screw may be used as the feed screw. The bearing is a thrust bearing, and a thrust ball bearing or a thrust roller bearing may be used, for example. Additionally, coupling the feed screw to the electric motor via the speed reducer facilitates the generation of high torque with a small electric motor. In one example, the speed reducer is a gearbox composed of a plurality of gears. The electric motor may be a geared motor having an integral structure combined with a speed reducer.

### Advantageous Effects of Invention

According to the present invention, it is possible to achieve an electric tool having a structure that has a high level of safety while improving the reliability of processing operations.

### BRIEF DESCRIPTION OF DRAWINGS

FIG. 1 is a circuit block diagram showing an example of a schematic circuit configuration of an electric tool according to the present embodiment.

FIG. 2 is a current waveform graph showing an example of a schematic current waveform in an electric tool of the present embodiment.

FIG. 3 is a schematic perspective view showing an example of the electric tool according to the present embodiment.

FIG. 4A is a rear view of the electric tool shown in FIG. 3, FIG. 4B is a right side view of the electric tool shown in FIG. 3, FIG. 4C is a front view of the electric tool shown in FIG. 3, and FIG. 4D is a left side view of the electric tool shown in FIG. 3.

FIG. 5A is a schematic structural diagram showing a state in which a cover part is removed from the electric tool of FIG. 3, and FIG. 5B is a structural diagram showing the relationship between a trigger lever and a switch substrate of the electric tool of FIG. 3.

FIG. 6A is a left side view of a tool head of the electric tool shown in FIG. 3, and FIG. 6B is a front view of the tool head of the electric tool shown in FIG. 3.

FIG. 7A is a schematic structural diagram showing an initial state in a usage mode of the electric tool shown in FIG. 3, FIG. 7B is a schematic structural diagram showing a state in which a work is attached in the usage mode of the electric tool shown in FIG. 3, FIG. 7C is a schematic structural diagram showing a state in which the work is compressed or crimped in the usage mode of the electric tool shown in FIG. 3, and FIG. 7D is a schematic structural diagram showing a state in which the work is removed in the usage mode of the electric tool shown in FIG. 3.

FIG. 8 is a schematic front view of the electric tool shown in FIG. 3, showing an example in which the positions of the first jaw and the second jaw are interchanged.

FIG. 9 is a diagram showing an example in which the electric tool shown in FIG. 3 is placed in a horizontal position.

### DESCRIPTION OF EMBODIMENTS

Referring to the drawings, an embodiment of the invention is now described in detail. An electric tool 1 of this embodiment is a multifunctional electric tool 1 with a replaceable tool head 3. Here, to facilitate the explanation of the positional relationship of parts of the electric tool 1, the directions are indicated by arrows of X, Y, and Z in the drawings. The electric tool 1 operates normally in any direction.

The electric tool 1 of this embodiment is configured to compress or crimp a work 90 by driving an electric motor 7a using a battery pack 5 attached to an adapter 4 of a main body 2 as a power source.

In one example, the electric tool 1 is used to crimp a crimping terminal and an electric wire at a work site, to join electric wires by compressing a crimping sleeve at a work site, or to compress or crimp the work 90 in a factory or workshop, for example. Throughout the figures illustrating embodiments, members having the same functions are denoted by the same reference numerals, and repeated descriptions thereof may be omitted.

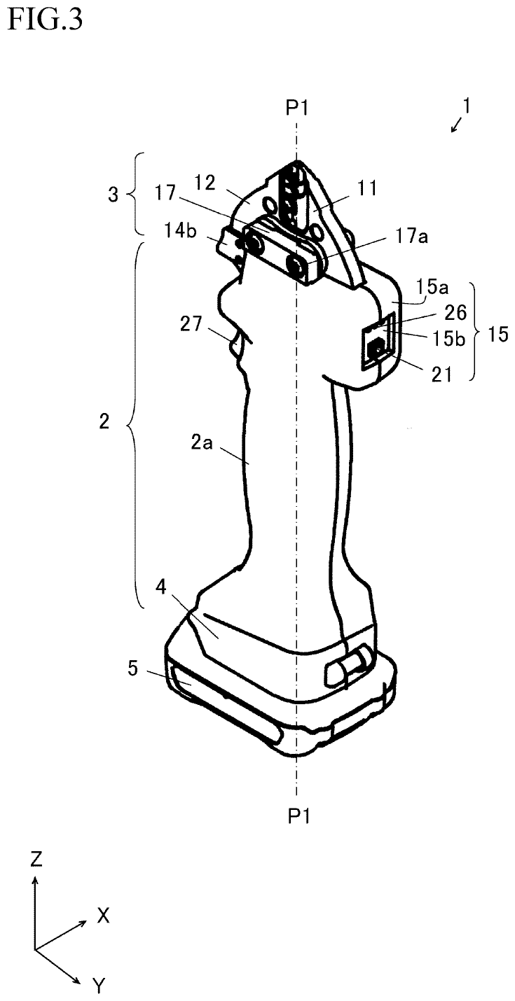

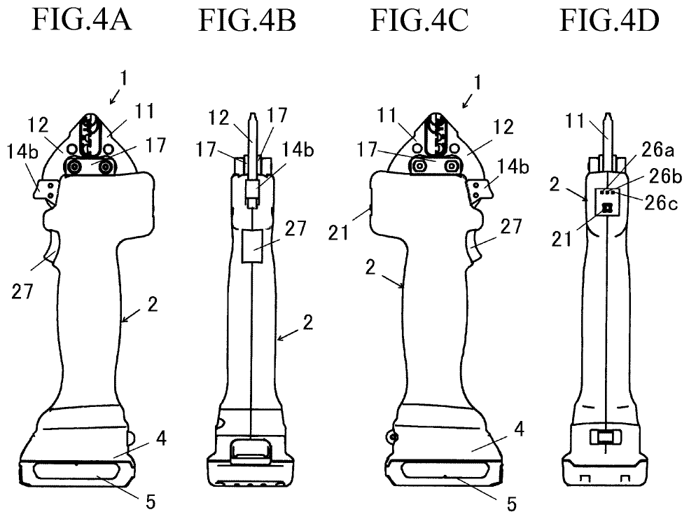

FIG. 3 and FIGS. 4A to 4D are schematic diagrams showing an example of the electric tool 1 according to the present embodiment. The electric tool 1 includes the main body 2, which includes the electric motor 7a, a feed screw 8a, a slide part 9, a control part 19, and a control switch 21, a tool head 3, which is coupled to the main body 2 and includes a first jaw 11 and a second jaw 12 pivotally coupled to each other, and the battery pack 5, and is a cordless type tool that is hand-held by an operator at a work site. The slide part 9 reciprocates along an axis Pl of the feed screw 8a. The slide part 9 advances to the upper limit position in the direction of the Z-direction arrow in the drawing, and retracts to the lower limit position in the direction opposite to the Z-direction arrow in the drawing. When the slide part 9 is stopped at an intermediate position, the distal end side of the tool head 3 is closed. In the initial state before the power is turned ON and the electric motor 7a starts to operate, and in the initial state after the operation of the electric motor 7a is finished and the power is turned OFF, the slide part 9 is stopped at the intermediate position.

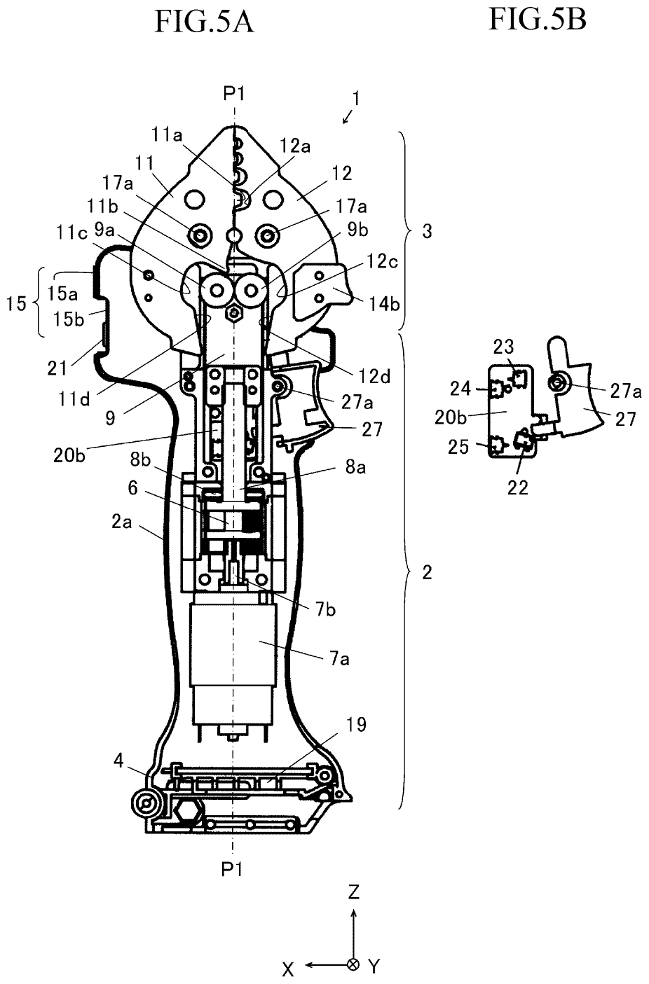

FIG. 5A is a schematic structural diagram showing a state in which one side of a cover part 2a of the main body 2 of the electric tool 1 is removed, and FIG. 5B is a structural diagram showing the relationship between a trigger lever 27 and a switch substrate 20a of the electric tool 1. The main body 2 has a horizontal placement part 15, which is formed in the cover part 2a and allows the main body 2 to be placed in a horizontal position. The horizontal placement part 15 includes a flat part 15a and a recessed part 15b. The flat part 15a has a flat surface formed around the recessed part 15b. The recessed part 15b. The recessed part 15b accommodates the control switch 21, and the control switch 21 is lower in height than the flat part 15a. The horizontal placement part 15 is in the right position when a trigger switch 22, which is activated in conjunction with the operation of the trigger lever 27, is set to the right position, and the horizontal placement part 15 is in the lower position when the trigger switch 22 is set to the upper position. This configuration increases the stability of the main body 2 when placed in a horizontal position and prevents erroneous operation of the control switch 21.

In one example, the control switch 21 is a push switch. The trigger lever 27 is pivotally supported by a second shaft member provided in the main body 2, and the trigger switch 22 is activated in conjunction with the trigger lever 27. The trigger switch 22 is a microswitch. A plurality of microswitches capable of detecting the position of the slide part 9 are mounted on the switch substrate 20a. In one example, the position of the slide part 9 is detected when a pin provided on the slide part 9 comes into contact with a microswitch.

The tool head 3 processes the work 90 using the principle of leverage. The first jaw 11 has a first slide surface 11d, which is formed on the rear end side of the first jaw 11 and on which a first roller 9a slides, and a first curved part 11c extending from a projecting part 11b of the first jaw 11 to the first slide surface 11d has a hollowed shape so as to be separated from the first roller 9a. Also, the second jaw 12 has a second slide surface 12d, which is formed on the rear end side of the second jaw 12 and on which a second roller 9b slides, and a second curved part 12c extending from an inner edge part, which is adjacent to a location where the first shaft member is located, to the second slide surface 12d has a hollowed shape so as to be separated from the second roller 9b. The first roller 9a and the second roller 9b form a pair of rollers, and the pair of the first roller 9a and the second roller 9b are disposed symmetrically with respect to the axis P1 of the feed screw 8a. In other words, one of the rollers is disposed at a position slidable to the rear end side of the first jaw 11, and the other roller is disposed at a position slidable to the rear end side of the second jaw 12.

The feed screw 8a is supported by a bearing 8b and is coupled to a drive shaft 7b of the electric motor 7a via a speed reducer 6. The cover part 2a of the main body 2 has the shape of a handle that can be gripped by the operator and extends in a direction away from the tool head 3. The adapter 4 is provided on the lower end side of the cover part 2a, and the battery pack 5 is connected to the adapter 4.

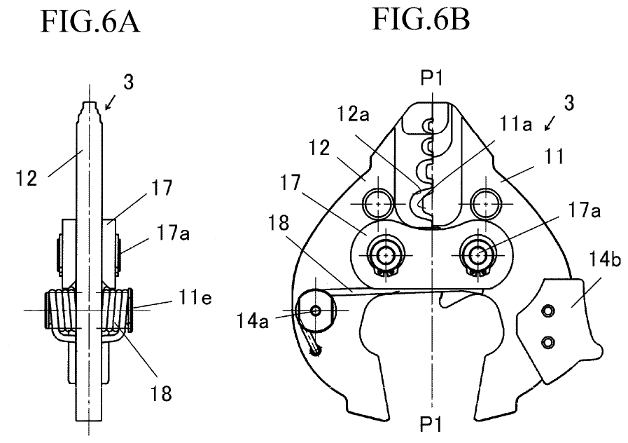

FIGS. 6A and 6B are an example of the tool head 3 used to compress or crimp the work 90. The first jaw 11 and the second jaw 12 are individually supported by first shaft members 17a inserted therein and pivotally coupled to each other by a coupling bar 17. A first shape part 11a on the distal end side of the first jaw 11 faces inward and has a male shape including protrusions formed at predetermined intervals, and a second shape part 12a on the distal end side of the second jaw 12 faces inward and has a female shape including recesses formed in one-to-one correspondence to the protrusions. Then, the first shape part 11a on the distal end side of the first jaw 11 and the second shape part 12a on the distal end side of the second jaw 12 are brought closer to each other to compress or crimp a compression terminal or a crimping sleeve as the work 90. A spring 18 is a torsion coil spring. A coil part of the spring 18 is pivotally attached to a support part 14a provided in the first jaw 11.

An end part of the spring 18 is in contact with the coupling bar 17. The restoring force of the spring 18 urges the first shape part 11a on the distal end side of the first jaw 11 and the second shape part 12a on the distal end side of the second jaw 12 in directions toward each other. In one example, the spring 18 is made of metal.

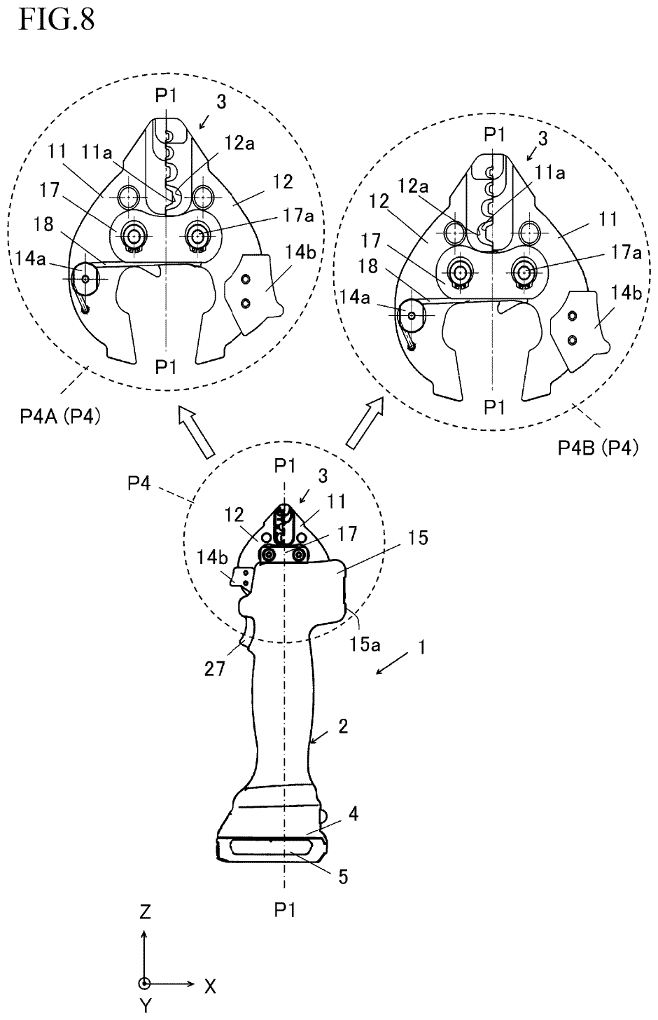

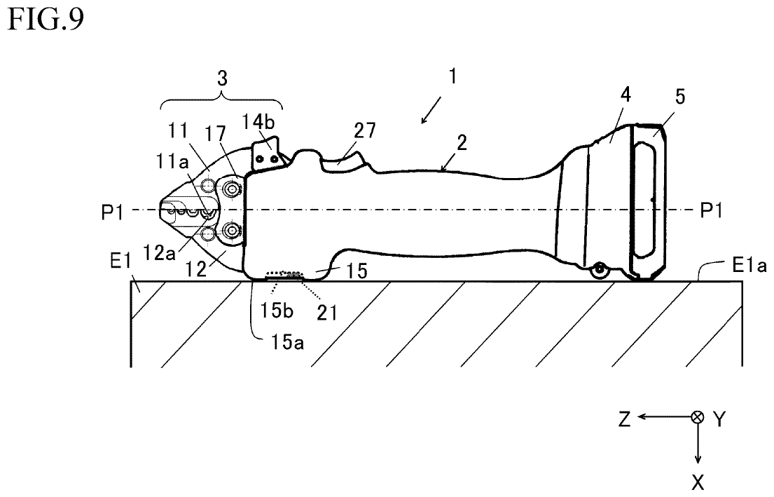

FIG. 8 is a schematic front view showing an example of the electric tool 1 according to the present embodiment, in which the positions of the first jaw 11 and the second jaw 12 are interchanged. FIG. 9 is a diagram showing an example in which the main body 2 is placed in a horizontal position on a workbench E1. According to this embodiment, since the main body 2 includes the horizontal placement part 15, the main body 2 can be placed in a horizontal position as shown in FIG. 9. When the main body 2 is placed in a horizontal position on the workbench E1, the flat part 15a of the horizontal placement part 15 comes into planar contact with a placement surface E1a, and a part of the battery pack 5 comes into planar contact with the placement surface E1a, so that the main body 2 stands on its own in the horizontal position. In the example shown in FIG. 9, the trigger lever 27 is on the upper side, the first jaw 11 is on the upper side, and the second jaw 12 is on the lower side. The second shape part 12a on the distal end side of the second jaw 12 faces inward and has a female shape including recesses. This allows a compression terminal or a crimping sleeve as the work 90 to be easily set. As a result, the work 90 can be easily processed.

As shown in FIG. 8, the first jaw 11 and the second jaw 12 are shaped so that they can be attached with their positions interchanged. Also, the first jaw 11 and the second jaw 12 can compress or crimp the work 90 in any situations where their positions are interchanged. The support part 14a can be attached to the attachment hole formed in the first jaw 11, and an operation part 14b can be attached in place of the support part 14a. Also, the arrangement configuration is such that the operation part 14b can be attached to the attachment hole formed in the second jaw 12, and the support part 14a can be attached in place of the support part 14a.

According to this configuration, an operation can be performed with the positions of the first jaw 11 and the second jaw 12 interchanged in accordance with the operator's dominant hand and the layout of the work site. In one example, an operation can be performed in a horizontal position, thereby facilitating the alignment of the work 90 and allowing the work 90 to be processed in an aligned state. Moreover, the movement of the slide part 9, which includes the first roller 9a and the second roller 9b positioned symmetrically with respect to the axis P1, provides a balance between the external force applied to the first jaw 11 the external force applied to the second jaw 12, thereby enabling the work 90 to be processed accurately and reliably while reducing power consumption.

In one example, the main body 2 includes the battery pack 5, which supplies power to the electric motor 7a, and the adapter 4, to which the battery pack 5 is detachably attached. This eliminates the need for a power cord, allows the operation range to be enlarged, and provides a compact, easy-to-use structure. The cover part 2a of the main body 2 has the shape of a handle that can be gripped by the operator and extends in a direction away from the tool head 3. The adapter 4 is provided below the handle-shaped cover part 2a. In one example, the main body 2 can process the work 90 while standing on its own in a horizontal position. This facilitates a stable operation with the main body 2 placed in a horizontal position.

The main body 2 includes a lower limit switch 25, which is activated by movement of the slide part 9 to the lower limit position, an intermediate switch 24, which is activated by movement of the slide part 9 to the intermediate position, and an upper limit switch 23, which is activated by movement of the slide part 9 to the upper limit position. In the main body 2, the distal end side of the first jaw 11 and the distal end side of the second jaw 12 are urged by the spring 18 and thus closed when the slide part 9 is at the intermediate position, and the distal end side of the first jaw 11 and the distal end side of the second jaw 12 are brought closer to each other to process the work 90 by retracting and moving the slide part 9.

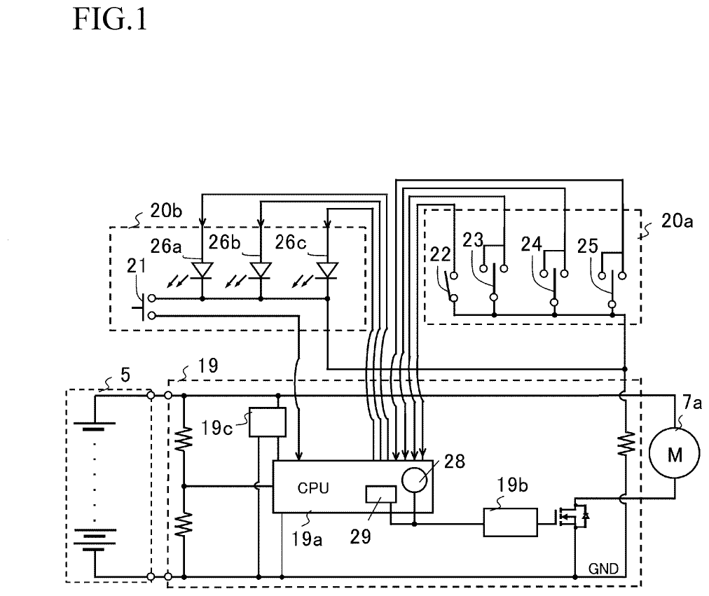

FIG. 1 is a circuit block diagram showing an example of a schematic circuit configuration of the electric tool 1. The control part 19 has, for example, a CPU 19a formed by a one-chip microcomputer. Next, the control part 19, and the switch substrate 20a and an indication substrate 20b that constitute peripheral circuits are described below.

The battery in the battery pack 5 is a lithium-ion battery, and, in one example, the power supply voltage is 7 to 42 [V], and the battery capacity is 1 to 10 [Ah]. The voltage of the battery pack 5 is stepped down via a regulator 19c and supplied to the CPU 19a. The CPU 19a checks and monitors the remaining amount of the battery pack 5. The control part 19 includes a current sensor 29, which detects the current of the electric motor 7a, and a timer 28, which measures time. In one example, the CPU 19a includes a sensor circuit, which functions as the current sensor 29, and a timer circuit, which functions as the timer 28. In one example, the CPU 19a sends a PWM signal to a driver 19b, supplies power to the electric motor 7a through a drive element such as a power MOSFET, and controls and drives the electric motor 7a.

The control part 19, the switch substrate 20a, and the indication substrate 20b are signal-connected by wiring. On the switch substrate 20a, the trigger switch 22, which is activated by operation of the trigger lever 27, the upper limit switch 23, which is activated by the slide part 9 moving to the upper limit position, the intermediate switch 24, which is activated by the slide part 9 moving to the intermediate position, and the lower limit switch 25, which is activated by the slide part 9 moving to the lower limit position, are mounted. When an activation signal of each switch is input to the CPU 19a, the CPU 19a drives and controls the electric motor 7a.

The main body 2 includes a display part 26, and the display part 26 is composed of an LED 26a, an LED 26b, and an LED 26c. The control switch 21, which is operated by the operator, the LED 26a, which indicates that the electric tool 1 is in an automatic mode, the LED 26b, which indicates that the electric tool 1 is in an abnormal state, and the LED 26c, which indicates that the electric tool 1 is in a manual mode, are mounted on the indication substrate 20b. The control switch 21, the LED 26a, the LED 26b, and the LED 26c are accommodated in the recessed part 15b. When an activation signal of the control switch 21 is input to the CPU 19a, the CPU 19a determines that an activation signal of the trigger switch 22 is a valid signal, and sets conditions for driving and controlling the electric motor 7a. The control switch 21 is a push switch, and when the intermediate switch 24 is ON and the control switch 21 is pressed for a predetermined period, for example, pressed for 3 seconds or longer, the mode is switched each time. The automatic mode is used for continuous operation, and the LED 26a lights up under the indication control of the CPU 19a to indicate green, for example. The manual mode is used for one-time operation, and the LED 26c lights up under the indication control of the CPU 19a and indicates green, for example.

When the electric tool 1 is in an abnormal state, an abnormal signal is input from an external sensor to the CPU 19a, and the LED 26b lights up or blinks under the indication control of the CPU 19a and indicates red, for example. In one example, when the current value of the battery pack 5 exceeds 20 [A], the LED 26b blinks ten times at a cycle of 5 Hz. In one example, when the substrate temperature of the control part 19 reaches 80 [° C.], the LED 26b lights up for 3 seconds. In one example, when the temperature of the battery pack 5 is 90 [° C.] or higher, the LED 26b blinks three times at a cycle of 1 Hz. In one example, when the voltage of the battery pack 5 is 7.8 [V] or less, the LED 26b blinks ten times at a cycle of 5 Hz. It should be noted that the above values are examples, and there is no limitation to the above values.

Table 1 below shows the relationship among the operation by the operator, the operation of the electric tool 1, and the operations of the control switch 21, the trigger switch 22, the upper limit switch 23, the intermediate switch 24, and the lower limit switch 25. In Table 1, the first switch is the control switch 21 and the second switch is the trigger switch 22.

TABLE 1

| | | | Control | Trigger | Upper limit | Intermediate | Lower limit |
|---|---|---|---|---|---|---|---|
| Step | Operator | Electric tool | switch | switch | switch | switch | switch |
| | — | Power OFF | OFF | OFF | OFF | ON | OFF |
| S1 | Presses and releases | Power ON, and enabled the second | → ON → | OFF | OFF | ON | OFF |
| | the first switch | switch | OFF | | | | |
| S2 | Attaches the work | Grips the work | OFF | OFF | OFF | ON | OFF |
| S3 | Grips the trigger lever | Crimps the work | OFF | ON | OFF | OFF | → ON |
| S4 | Releases the trigger | Opens the tool head | OFF | OFF | → ON | OFF | OFF |
| | lever | | | | | | |
| S5 | Removes the work | After a period from release the | OFF | OFF | OFF | ON | OFF |
| | | trigger lever. the power OFF | | | | | |

As shown in Table 1, while the simple configuration in which the control switch 21 and the trigger switch 22 in conjunction with the trigger lever 27 are combined is provided, the usability is satisfactory because the operator can easily perform a series of necessary operations with one hand. Moreover, the power is turned ON when the control switch 21 is activated, and the power is turned OFF after a predetermined stand-by time has elapsed since the point in time when the trigger lever 27 is released, which is rational. In one example, the power is turned OFF 60 seconds after the point in time when the trigger lever 27 is released.

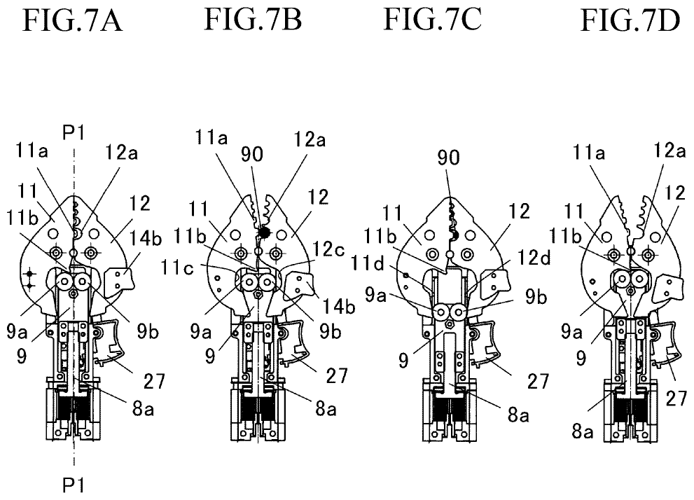

FIGS. 7A to 7D are schematic structural diagrams illustrating the operation of the electric tool 1. The operation of the electric tool 1 is described below with reference to FIGS. 7A to 7D and Table 1.

FIG. 7A shows the initial state in which the slide part 9 is at the intermediate position. The intermediate position is a position at which the first roller 9a is in contact with or adjacent to the projecting part 11b. When the power is OFF, only the intermediate switch 24 is ON. When the slide part 9 is at the intermediate position, the restoring force of the spring 18 closes the distal end side of the first jaw 11 and the distal end side of the second jaw 12. The first crimping operation starts from the initial state of the slide part 9 shown in FIG. 7A.

At step S1, when the operator presses and releases the control switch 21, the control switch 21 is turned from OFF to ON and then OFF, the power is turned ON under the control of the control part 19, and the activation of the trigger switch 22 is enabled.

Following step S1, at step S2, the operator presses the operation part 14b attached to the second jaw 12 in the direction of the first jaw 11, so that the first shape part 11a is separated from the second shape part 12a, and the operator attaches the work 90. FIG. 7B shows a state in which the work 90 is held between the first shape part 11a and the second shape part 12a.

Following step S2, at step S3, when the operator grips the trigger lever 27, the slide part 9 retracts and moves downward, the first roller 9a slides on the first slide surface 11d, the second roller 9b slides on the second slide surface 12d, and thus the first shape part 11a and the second shape part 12a move closer to each other to crimp the work 90. When the slide part 9 reaches the lower limit position, the lower limit switch 25 is activated and the slide part 9 temporarily stops. FIG. 7C shows a state in which the work 90 is crimped.

Following step S3, at step S4, when the operator releases the trigger lever 27, the slide part 9 advances and moves upward, and the first roller 9a pushes the projecting part 11b thereby separating the first shape part 11a and the second shape part 12a from each other. When the slide part 9 reaches the upper limit position, the upper limit switch 23 is activated and the slide part 9 temporarily stops.

Following step S4, at step S5, the operator removes the work 90. FIG. 7D shows a state in which the work 90 is removed. After a predetermined period since the point in time when the operator releases the trigger lever 27, the power is turned OFF with the distal end side of the first jaw 11 and the distal end side of the second jaw 12 closed.

In the automatic mode, the crimping operation is repeated from the state shown in FIG. 7D. In the manual mode, the crimping operation is performed one by one from the state shown in FIG. 7A.

According to the present embodiment, the work 90 can be easily aligned by holding the work 90 with a constant force, and the aligned work 90 can be easily processed. Additionally, since the distal end side of the tool head 3 is closed in the initial state in which the slide part 9 is at the intermediate position, the electric tool 1 has a structure that can reduce the burden on the operator and has a high level of safety as compared to conventional products.

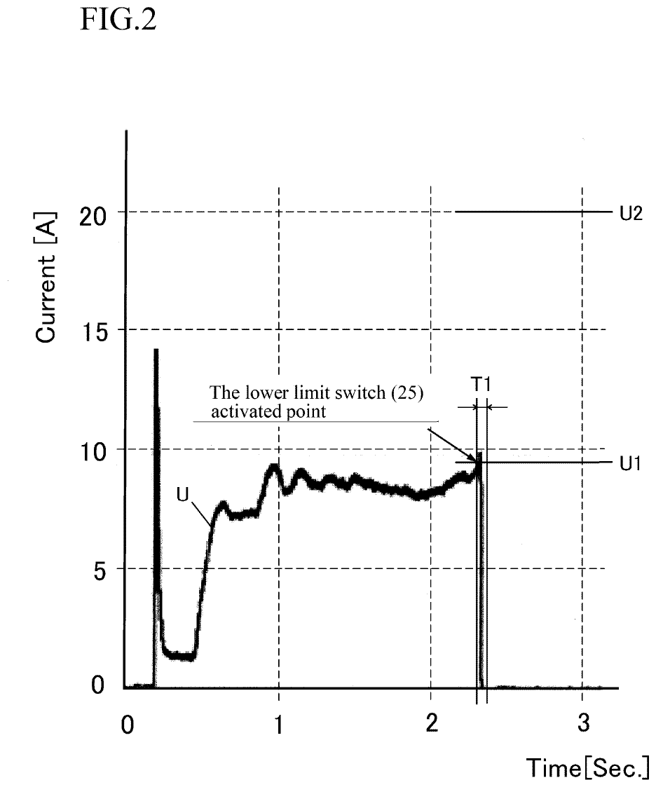

FIG. 2 is a current waveform graph showing an example of a current waveform U in the electric tool 1. In addition to the above description, the operation of the electric tool 1 is described below with reference to FIG. 1.

At step S3, when the operator grips the trigger lever 27, a processing operation starts, the slide part 9 retracts to proceed the processing operation, and the lower limit switch 25 is activated. In one example, the processing operation time is 1 to 3 [seconds]. When the detection value of the current sensor 29 exceeds the first current value U1 but does not exceed the second current value U2 at the point in time when the lower limit switch 25 is activated, the control part 19 determines that the processing of the work 90 is normal and performs the subsequent continuous process. When the second current value U2 is exceeded at the point in time when the lower limit switch 25 is activated, it is determined that there is an abnormality, and an abnormality process is performed. In one example, the first current value U1 is 8.5 to 9.5 [A], and the second current value U2 is 19.5 to 20.5 [A].

When the detection value of the current sensor 29 does not exceed the first current value U1 at the point in time when the lower limit switch 25 is activated, the control part 19 continues the actuation of the feed screw 8a. When the detection value is below the second current value U2 at the point in time when a set time T1 has elapsed since exceeding the first current value U1, the control part 19 determines that the processing of the work 90 is normal and performs the subsequent continuous process. Also, when the detection value exceeds the second current value U2 at the point in time when the set time T1 has elapsed, it is determined that there is an abnormality, and an abnormality process is performed. In one example, the set time T1 is 5 to 15 [ms].

When determining that the processing of the work 90 is normal, the control part 19 controls to move the slide part 9 to the intermediate position. Alternatively, when determining that the processing of the work 90 is normal, the control part 19 controls to move the slide part 9 to the upper limit position and then move the slide part 9 to the intermediate position. Furthermore, when determining that there is an abnormality, the control part 19 transmits an error signal to the display part 26 and performs the above-mentioned stop control.

According to this embodiment, the electric tool 1 has a structure that has a high level of safety while improving the reliability of processing operations.

1. An electric tool comprising:
a main body including an electric motor, a feed screw to be actuated by the electric motor, a slide part to be moved by the feed screw, and a control part; and
a tool head that is coupled to the main body and includes a first jaw and a second jaw pivotally coupled to each other,
wherein the tool head is provided with a spring that urges a distal end side of the first jaw and a distal end side of the second jaw in directions toward each other, processes a work with a first shape part of the distal end side of the first jaw and a second shape part of the distal end side of the second jaw, and includes a current sensor that detects a current of the electric motor and a lower limit switch that is activated by movement of the slide part to a lower limit position, and
the control part determines that processing of the work is normal and performs a subsequent continuous process when a detection value of the current sensor exceeds a first current value and does not exceed a second current value at a point in time when the lower limit switch is activated, and determines that there is an abnormality and performs an abnormality process when the second current value is exceeded at the point in time when the lower limit switch is activated.

2. The electric tool according to claim 1, wherein the control part continues actuation of the feed screw when the detection value does not exceed the first current value at the point in time when the lower limit switch is activated, determines that processing of the work is normal and performs a subsequent continuous process when the detection value is below the second current value at a point in time when a set time has elapsed since the detection value exceeds the first current value, and determines that there is an abnormality and performs the abnormality process when the detection value exceeds the second current value at the point in time when the set time has elapsed.

3. The electric tool according to claim 1, wherein
the main body includes a display part, the lower limit switch, an intermediate switch that is activated by movement of the slide part to an intermediate position, and an upper limit switch that is activated by movement of the slide part to an upper limit position,
the control part performs control that moves the slide part to the intermediate position when the control part determines that the processing of the work is normal, or performs control that moves the slide part to the upper limit position and moves the slide part to the intermediate position when the control part determines that the processing of the work is normal, and
the control part transmits an error signal to the display part when the control part determines that there is an abnormality.

4. The electric tool according to claim 2, wherein
the main body includes a display part, the lower limit switch, an intermediate switch that is activated by movement of the slide part to an intermediate position, and an upper limit switch that is activated by movement of the slide part to an upper limit position,
the control part performs control that moves the slide part to the intermediate position when the control part determines that the processing of the work is normal, or performs control that moves the slide part to the upper limit position and moves the slide part to the intermediate position when the control part determines that the processing of the work is normal, and
the control part transmits an error signal to the display part when the control part determines that there is an abnormality.

5. The electric tool according to claim 3, wherein
the main body includes a trigger switch and a control switch, and
the control part performs stop control that moves the slide part to the intermediate position and stops the slide part when the trigger switch is released and the control switch is operated before the lower limit switch is activated, and performs the stop control when neither the trigger switch nor the control switch is operated after a stand-by time has elapsed since a point in time when the intermediate switch is activated.

6. The electric tool according to claim 4, wherein
the main body includes a trigger switch and a control switch, and
the control part performs stop control that moves the slide part to the intermediate position and stops the slide part when the trigger switch is released and the control switch is operated before the lower limit switch is activated, and performs the stop control when neither the trigger switch nor the control switch is operated after a stand-by time has elapsed since a point in time when the intermediate switch is activated.

7. The electric tool according to claim 1, wherein
the main body includes a battery pack that supplies power to the electric motor and an adapter to which the battery pack is detachably attached, and
the slide part is provided with a first roller disposed at a position slidable to a rear end side of the first jaw and a second roller disposed at a position slidable to a rear end side of the second jaw, and movement of the slide part to the lower limit position compresses or crimps the work.
